(19) United States
(12) Patent Application Publication
(10) Pub. No.: US 2020/0134519 A1
(43) Pub. Date: Apr. 30, 2020

(54) RISK MANAGEMENT SYSTEM

(71) Applicant: Pande RAKESH, Mumbai (IN)

(72) Inventor: Pande RAKESH, Mumbai (IN)

(21) Appl. No.: 16/172,361

(22) Filed: Oct. 26, 2018

(51) Int. Cl. G06Q 10/06; G06Q 10/10; G06F 11/07; G06F 17/30

(52) U.S. Cl. CPC G06Q 10/0635; G06Q 10/06311; G06Q 50/30; G06F 11/079; G06F 17/30598; G06Q 10/1097

(57) ABSTRACT

The present disclosure provides a risk management system that undertakes proactive risk assessment and suggests appropriate controls to mitigate risks. Moreover, the risk management system undertakes risk assessment based in three or more parameters. Further, the risk management system assesses strength or weakness of management components or departments.

### BACKGROUND OF THE INVENTION

### Field of the Invention

The present disclosure relates to the field of risk management. More particularly, the present disclosure relates to a risk management system for aviation industry.

### Description of the Related Art

In the aviation industry, presently all automated systems that related to safety are ‘Reporting Systems’ viz. these systems record incidents and that are reported to appropriate authorities (e.g. Regulatory Authority). At best, some of the systems create trend analysis to show how many incidents occurred in a particular period, within a given region, related to a particular subject, etc. In other words, all these systems are reactive in nature. These systems lack ability to proactively flag potential risk area. In addition, conventional systems are not able to help improve organizational functions (or departments) efficiencies. In light of the above discussion, there exists a need for a proactive and predictive risk management system, which overcomes the above cited drawbacks of conventional automated systems.

### BRIEF SUMMARY OF THE INVENTION

This disclosure concerns a risk management system includes at least one storage and at least one processor. The at least one storage stores a plurality of modules where each module is a collection of instructions of an application operable in the risk management system. The at least one processor of the risk management system executes the plurality of modules. The plurality of modules includes an input recorder module, a case assignment module, a level one review module, an analysis module, a root cause management module, a control management module, a keywords module, a task management module and an MIS module.

A primary object of the disclosure is to provide a risk management system that has predictive capabilities.

Another object of the present disclosure is to provide the risk management system that allows periodic monitoring and review of root causes and associated controls.

Yet another object of the present disclosure is to provide the risk management system that is capable of undertaking proactive risk assessment of new aviation operations.

Yet another object of the present disclosure is to provide the risk management system that undertakes risk assessment along with appropriate controls to mitigate risks for new aviation operations.

Another object of the present disclosure is to provide the risk management system that is capable of undertaking risk assessment based in several parameters.

Yet another object of the present disclosure is to provide the risk management system that is capable of assessing strength or weakness of management components or departments.

### DESCRIPTION OF THE DRAWINGS

Having thus described the disclosure, in general, terms, and for a more complete understanding of the present disclosure, reference will now be made to the accompanying figures, wherein:

FIG. 1 illustrates a block diagram of a risk management system, in accordance with an embodiment of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### REFERENCE NUMERALS IN THE DRAWINGS

For a more complete understanding of the present invention parts, reference is now made to the following descriptions:
100. Risk management system.
105. Storage.
110. Processor.
115. Input recorder module.
120. Case assignment module.
125. Level one review module.
130. Analysis module.
135. Root cause analysis module.
140. Risk computation module.
145. Approval module.
150. Root cause management module.
155. Control management module.
160. Keywords module.
165. Task management module.
170. MIS module.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention.

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

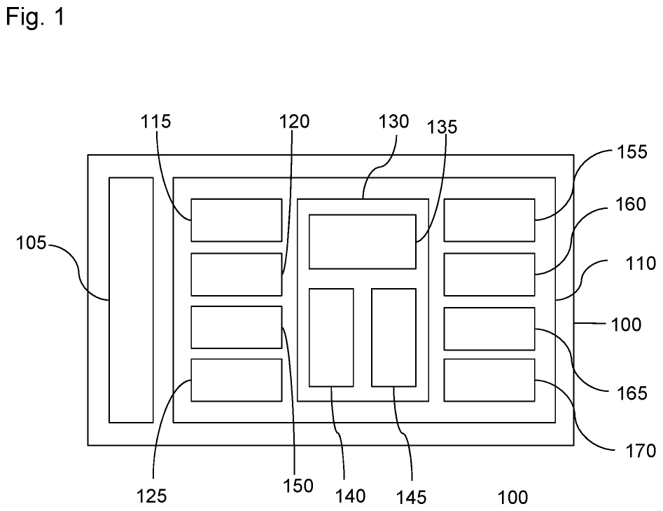

FIG. 1 illustrates a block diagram of a risk management system 100, in accordance with an embodiment of the present disclosure. The risk management system 100 includes at least one storage 105 and at least one processor 110. The at least one storage 105 stores a plurality of modules where each module is a collection of instructions of an application operable in the risk management system 100. In an embodiment of the present disclosure, the at least one storage 105 is distributed over several physical locations such as central cloud serves, local server, local mobile devices, local computer, a combination of these, and so forth. In an embodiment of the present disclosure, the at least one storage 105 is can be a single cloud storage. It will be apparent to a person ordinarily skilled in the art that there are various ways to distribute the at least one storage 105 of the risk management system 100 across physical locations without affecting the scope of the disclosure. The at least one processor 110 of the risk management system 100 executes the plurality of modules. The plurality of modules includes an input recorder module 115, a case assignment module 120, a level one review module 125, an analysis module 130, a root cause management module 150, a control management module 155, a keywords module 160, a task management module 165 and an MIS module 170. The input recorder module 115 receives one or more input sets from one or more sources. For example, the one or more sources can be one or more of the following a safety reporting, a questionnaire, a survey, flight data monitoring, a safety and quality audit, an operation, a moderated session with internal experts, a brainstorm sessions on new or known hazards, an external source and the categories of safety reporting by International Civil Aviation Organization (ICAO).

Subsequently, the case assignment module 120 assigns a risk case number to each of the one or more input sets such that each the risk case number is unique. The risk case number relates to either an existing risk case or a new risk case. In other words, inputs received by the input recorder module 115 either relates to new case or for an existing case. For example, a user may share a photograph of debris on the runway, and the case assignment module 120 will assign a new and unique risk case number to such inputs. In another example, an analyst may enter structured information relating to a root cause analysis for an existing risk case number. Further, the case assignment module 120 assigns each risk case number to a predefined safety officer and a predefined approving authority. For example, when a user enters a photograph of debris on the runway through an app on this mobile phone, a new risk case number is assigned and a safety officer and an approving authority is assigned for the risk case number. In an embodiment of the present disclosure, assignment of a safety officer and an approving authority to a risk case number can be based on rules and criteria defined in the risk management system 100. In another embodiment of the present disclosure, assignment of a safety officer and an approving authority to a risk case number can be offline consultation by relevant stakeholders.

Further, the level one review module 125 performs exactly one action from a first plurality of actions for the risk case number, based on inputs of the predefined safety authority. The first plurality of actions can be one of initiate a risk computation, initiate a root cause analysis, and a closure. For example, the level one review module 125 can close the risk case number if the safety officer determines inputs to the risk case number as insignificant. If the risk case number is closed, it is not referred to subsequent modules. In another example, the level one review module 125 can initiate a root cause analysis if the safety officer determines that the risk case number as a fit case for the same. In addition, the level one review module 125 defines one or more predefined analysts and a predefined ultimate accountable department when either risk assessment or a root cause analysis is initiated. In an embodiment of the present disclosure, the level one review module 125 assigns a predefined category to the risk case number. The predefined category can be ICAO classifications or Country specific classification. ICAO classification as per ECCAIRS Aviation 1.3.0.12 VL for AttrID : 431—Occurrence Classes dated 29 Apr. 2013 is an accident, a serious incident, a major incident, a significant incident, an occurrence without safety effect, and ‘not determined’. Whereas, classification as per Director General Civil Aviation (DGCA), the aviation regulatory authority in India vide CAR Sec V, Series ‘C’ Part I, Issue II dated 20 Oct. 2015 is an incident, a serious incident, a significant incident and an accident. In another embodiment of the present disclosure, the level one review module 125 assigns a predefined category to the risk case number for the risk assessment analysis such that a three level deep classification is performed when the predefined category is Air Operations as per ICAO and a two level classification is performed when the predefined category is Hazard as per ICAO. Predefined category of Air Operations as per ICAO ECCAIRS Aviation 1.3.0.12 VL for AttrID: 214 Aviation Operations, is (a) Commercial Air Transport (b) General Aviation (c) Aerial Work. Each of these predefined categories are further sub-categorized. As an example, for Commercial Air Transport, the predefined sub-categories are (a) Revenue Operations (b) Non-revenue Operations (c) Others (d) Unknown. Predefined Category of Hazards as per ICAO Taxonomy Version 1, March 2014 are (a) Environmental (b) Technical (c) Organizational (d) Human. Each of these predefined categories are further sub-categorized. As an example, for Environmental, the predefined sub-categories are (a) Severe Weather or Climatic Conditions (b) Adverse Weather Conditions (c) Geographical events (d) Geography (e) Natural events (f) Public health events.

In yet another embodiment of the present disclosure, the level one review module 125 assigns a predefined category to the risk case number for the root cause analysis such that a three level classification is assigned when the predefined category is either a country specific incident and an incident as per ICAO. The first level classification as per ICAO, ECCAIRS Aviation 1.3.0.12 VL for AttrID: 431—Occurrence Classes dated 29 Apr. 2013 is (a) Accident (b) Serious Incident (c) Major Incident (d) Significant Incident (e) Occurrence without Safety effect (f) Not Determined. Whereas, classification as per Director General Civil Aviation (DGCA), the aviation regulatory authority in India vide CAR Sec V, Series ‘C’ Part I, Issue II dated 20 Oct. 2015 is (a) Incident (b) Serious Incident (c) Significant Incident (d) Accident. Second and third level classifications are as per ICAO, ECCAIRS Aviation 1.3.0.12 VL for AttrID:430—Occurrence category dated 29 Apr. 2013. Examples of Second Level are (a) Airborne (b) Aircraft (c) Ground Operations (d) Miscellaneous (e) Non-Aircraft related (f) Take-off and Landing (g) Weather. Each of the above second level classification is further sub-categorized. As an example, for Airborne (second level classification), the level three sub-categories are (a) Abrupt Maneuver (b) AIRPROX/TCAS Alert/ Lss of Separation/Near Mid-Air Collision/Mid-Air Collisions (c) Controlled Flight into/toward Terrain (d) Fuel Related (e) Glider towing related event (f) Loss of Control—Inflight (g) Loss of lifting conditions en-route (h) Low Altitude Operations (i) Unintended flight in IMC.

If the risk case number is not closed, it is subsequently transferred to the analysis module 130. The analysis module 130 includes a root cause analysis module 135, a risk computation module 140 and an approval module 145.

If the level one review module 125 initiates a root cause analysis for the risk case number, the root cause analysis module 135 identifies one or more root causes by undertaking a root cause analysis for the risk case number. The root cause analysis is performed independently by the one or more predefined analysts and the predefined ultimate accountable department such that the predefined ultimate accountable department recommends one or more new controls, one or more existing control or a combination of new and existing controls for the risk case number. For example, when a risk case number relating to debris on a runway is received by the root cause analysis module 135, two analysts and ground staff department can undertake independent root cause analysis. In addition, the ground staff department recommends new, existing or a combination of new and existing controls for the identified root causes, to ensure that identified root causes are do not repeat in the future. It is understood to a person ordinarily skilled in the art that the root cause analysis module 135 can perform several of above actions by itself, by using manual inputs or a combination of in-built intelligence and learning abilities supported by external inputs.

If the level one review module 125 initiates a risk assessment for the risk case number, the risk computation module 140 computes a first risk by undertaking a risk assessment for the risk case number. One or more predefined analysts and the predefined ultimate accountable department independently perform risk computation and recommend a first set of controls for the risk case number. In an embodiment of the present disclosure, the first set of controls is a combination of new and existing controls. In another embodiment of the present disclosure, the first set of controls is new set of controls. In yet another embodiment of the present disclosure, the first set of controls is existing controls that are or were put in place for other risk case numbers. For example, if night flights are initiated for the first time by an airline, one analyst and the planning department carry out independent risk assessment. The analyst may conclude risk of untrained pilots and the planning department may conclude risk due to lack of supporting technologies such as CAT6, and so forth. Further the analyst may suggest a new control of minimum 100 hours of night flight experience for pilots, and the planning department may suggest a new control of testing new night flying technologies for 50 take offs and landings and an several existing controls relating to maintenance. In an embodiment of the present disclosure, the risk computation module 140 lists the existing controls for the risk case number. The first risk is computed for existing controls based on exactly two predefined parameters namely a predefined likelihood and a predefined severity associated with the risk case number. The predefined likelihood and the predefined severity is based on ICAO.

| | Severity | | | | |
|---|---|---|---|---|---|
| Likelihood | 1-Insignificant | 2-Minor | 3-Moderate | 4-Major | 5-Catastrophic |
| A-Certain | Moderate(1A) | Moderate(2A) | High(3A) | Extreme(4A) | Extreme(5A) |
| B-Likely | Low(1B) | Moderate(2B) | Moderate(3B) | High(4B) | Extreme(5B) |
| C-Possible | Low(1C) | Low(2C) | Moderate(3C) | Moderate(4C) | High(5C) |
| D-Unlikely | Negligible(1D) | Low(2D) | Low(3D) | Moderate(4D) | Moderate(5D) |
| E-Exceptional | Negligible(1D) | Negligible(2E) | Low(3E) | Low(4E) | Moderate(5E) |

Further, the risk computation module 140 recommends action as per a risk acceptability matrix based on ICAO or user defined.

| | | Action Required (Customize as |
|---|---|---|
| Risk Index | Tolerability | appropriate) |
| 5A, 5B, 4A | Extreme | Stop Ops or Process Immediately. |
| | Risk | Unacceptable under existing |
| | | circumstances. |
| 5C, 4B, 3A | High Risk | Caution. Ensure Risk Assessment |
| | | undertaken & preventive measures |
| | | in place before commencement of Ops |
| 1A, 2A, 2B, | Moderate | Perform or review risk mitigation |
| 3B, 3C,4C, | Risk | as necessary. Approval for Risk |
| 4D, 5D, 5E | | Assessment required |
| 1B, 1C, 2C, | Low Risk | Risk Mitigation or review is |
| 2D, 3D,3E, | | optional |
| 4E | | |
| 1D, 1E, 2E | Negligible | Acceptable as is. No risk |
| | Risk | mitigation required |

In the above example, an Organization implementing Safety Management System may define “Negligible Risk” and “Low Risk” as acceptable and “Moderate Risk” and “High Risk” as acceptable only after application risk assessment & mitigating controls. In case of “Extreme Risk”, the Operations or Process must be immediately stopped.

In another embodiment of the present disclosure, the risk computation module 140 computed the first risk based on three or more predefined parameters. For example, risk computation based on five parameters can have following parameters Likelihood, Impact on People including Passengers, Impact on Systems including manual & technical systems, Impact on Aircraft Operations and Impact due to non-compliance. The values can be assigned from 1 to 5 (1 being low and 5 being high). For example, risk is to be computed for an event of oil spill on runway leading to aircraft skidding during landing. Risk is computed as Likelyhood×(Impact on People+Systems+Operations+Compliance). In this example, Likelyhood is rated as 2, Impact on people is rated as 4, Impact on systems is rated as 1, Impact on operation is rated as 5 and Impact on compliance is rated as 1. Risk is computed as 22. Action on the computed risk is as per the table below:

| | | Action Required (Customize as |
|---|---|---|
| Risk Score | Tolerability | appropriate) |
| More than 20 | Extreme | Stop Ops or Process Immediately. |
| | Risk | Unacceptable under existing |
| | | circumstances. |
| From 15 to | High Risk | Caution. Ensure Risk Assessment |
| 20 or (B, D | | undertaken & preventive measures |
| or E more | | in place beforecommencement of Ops |
| than 2) | | |
| From 11 to | Moderate | Perform or review risk mitigation |
| 15 and (B, | Risk | as necessary. Approval for Risk |
| D or E Not | | Assessment required |
| more than 2) | | |
| From 7 to | Low Risk | Risk Mitigation or review is |
| 10 and (B, D | | optional |
| or E Not | | |
| more than 2) | | |
| Less than 7 | Negligible | Acceptable as is. No risk |
| & (B, D or | Risk | mitigation required |
| E Not more | | |
| than 2) | | |

Moreover, if the predefined risk is not less than a predefined risk limit, one or more additional controls are recommended such that the predefined risk becomes less than the predefined risk limit. In an example when controls were implemented, the risk would be re-assessed. It is understood to a person ordinarily skilled in the art that the risk computation module 140 can perform several of above actions by itself, by using manual inputs or a combination of in-built intelligence and learning abilities supported by external inputs.

After either the root cause analysis module 135 has performed root cause analysis or the risk computation module 140 has performed risk assessment, the approval module 145 finalizes the risk computation, the root cause analysis and the first set of controls for the risk number, whichever applicable. For example, the approval module 145 finalizes risk assessment and applicable controls based on the independent risk assessments and recommended independent set of controls from an analyst and the ultimate accountable department (say HR department). The predefined approving authority, through the approval module 145, can initiate one-on-one discussion with the ultimate accountable department in a discussion forum module before finalization.

After finalization, a root cause management module 150 structures the root cause analysis in a first predefined structure and assigns a root cause number to the root cause analysis. It is apparent to a person ordinarily skilled in the art that the first predefined structure can be a customized internal format of an organization. When the root cause analysis substantially matches an existing root cause analysis, an existing root cause number is assigned to the root cause analysis. Otherwise a new and unique root cause number is assigned to the root cause analysis by the root cause management module 150. Subsequently, the root cause management module 150, based on inputs of the predefined safety officer, assigns a first plurality of predefined keywords to each of the identified root causes of the root cause analysis for the risk case number. The first plurality of predefined keywords must include at least one predefined management components and may include predefined aviation terms. In an embodiment of the present disclosure, the predefined aviation terms are as per ICAO, ECCAIRA 1.3.0.12. VL for AttrID: 390—Events. The predefined management components are policy and objectives, safety risk management, safety assurance and safety promotion. As an example, if an aircraft has done a hard landing, the Flight Data Recorder (FDR) would provide data regarding landing impact values for the case to be investigated for root cause(s). After analysis, the root cause may be identified as “lack of adequate training to the Pilot for landing during night hours”. This root cause would be linked to aviation term, “Hard Landing”, and management term “training & awareness” under the predefined category of key word “Safety Promotion”. By linking the predefined key word to root causes, the organization can easily identify all previous cases of “hard landing’ in the aviation organization and its associated controls. The linking of management component, in the said example being “Training & Awareness”, shows that the system of identifying “training needs & its subsequent action of undertaking training” is weak and needs remedial steps in the organization.

Further, the control management module 155 structures the first set of controls in a second predefined structure and assigns each control to exactly one accountable department. It is apparent to a person ordinarily skilled in the art that the second predefined structure can be a customized internal format of an organization. Further, the control management module 155 assigns a unique control id (identification) to each control of the first set of controls. Moreover, the control management module 155 assigns a responsible user, one or more consulted users, and one or more informed users based on inputs of the accountable department and one or more advisors. As an example, when debris were found on runway, the root cause was identified and one of the controls recommended was “inspection of the runway to clear debris at regular intervals”. The Safety Officer would then enter this control in a structured manner (in brief and in detail). This process of entering the control in a structured manner would allot a control id to the said control. A unique id will be allotted to the control if it is new, otherwise an existing control id would be linked to the said control. The Safety Officer will also identify the accountable department for the said control. In this example, it would be Runway Operations department. The Head of the Department of Runway Operations would therefore be accountable for the effective implementation & review of the control, viz., “inspection of the runway to clear debris at regular intervals”. In addition, the Safety Officer will identify personnel from Air Traffic Controlling Department, as users who need to be “Informed” when the runway inspection is being planned or being undertaken. In addition, some of the Users from Air Operations Team may also be added as users who need to be “Consulted” for implementation of the control (i.e. inspection of runway to clear debris). The following table demonstrates how each control is assigned to various persons/users (Responsible, Accountable, Consulted and Informed)

| | | Duty of | | | | |
|---|---|---|---|---|---|---|
| | | Responsible | | | | |
| | | Person to | | | | |
| | | Imple- | | | | |
| | Account- | menta- | Next | Respon- | Con- | In- |
| | able | tion | Review | sible | sulted | formed |
| Controls | Person | When? | When? | Person | User(s) | User(s) |
| Control-1 | Head of the | Date-1 | Date-2 | Person-1 | Person- | Person- |
| | Department | | | | 101, | 201, |
| | of | | | | Person- | Person- |
| | Person-1 | | | | 102, | 202, |
| | | | | | Person- | Person- |
| | | | | | 103 | 203 |
| | | | | | . . . | . . . |
| Control-2 | Head of the | Date-3 | Date-4 | Person-2 | Person- | Person- |
| | Department | | | | 201, | 101, |
| | of | | | | Person- | Person- |
| | Person-2 | | | | 202, | 102, |
| | | | | | Person- | Person- |
| | | | | | 203 | 103 |
| | | | | | . . . | . . . |
| Control-N | — | — | — | — | — | — |

Subsequently, submits the first set of controls to the predefined approving authority after discussion in a discussion forum module. After approval, the first set of controls become active. Finally, the control management module 155 schedules implementation and review of the first set of controls. Once the controls are approved, it will have to be implemented & reviewed as per the already approved dates by the person responsible for implementing the said control. As an example, if the runway was required to be cleared of any debris by Mr John (from Runway Operations Department), then the task management module 165 would add a pending task to the account of user, i.e. Mr John, to undertake/review the runway so that there are no debris are found on the runway, on a particular date & time. The head of the department of Mr John would also be kept informed about the pending task by the task management module 165. Once the task is completed, the user (Mr John) or his head of the department, can inform the task management module that the pending task (of implementing the control, i.e. clearing debris from runway) has been implemented/reviewed. Accordingly, the pending task would be removed from the list of Mr John and his head of the department. If the task is required to be repeated at regular or predefined intervals, then the next pending task would be added to the User's (i.e. Mr John's) pending task list. In this manner, the task management module 165 would keep track of all pending tasks of various ‘Responsible’ Users and keep the concerned ‘Accountable’ User, i.e. Head of the Department, informed of its status.

Further, a keywords module 160, based on inputs of the predefined safety officer, links the first set of controls and the risk case number to a second plurality of predefined keywords. The second plurality of predefined keywords includes the predefined aviation terms and at least one predefined management components. <Inventor to add a real life example of the above here by taking example of actual control and keywords in a given situation>. As an example, in the case of tyre burst on runway during landing it was analyzed that the root cause of tyre burst was due to metallic debris on the runway, a control to mitigate the event (i.e. tyre burst) from happening again would be to inspect & clear the runway from any such debris. In this case, the risk case number and control would be linked to aviation keywords such as, ‘tyre burst’ and “Foreign object control/removal (FOD)” and management keyword such as, “Hazard Identification” (under the category, “Safety Risk Management”). These key words would help the Organization relate to all similar cases which have happened earlier and thereby take improved actions in the regard.

Subsequently, the task management module 165 flags pending tasks to one or more users of the risk management system. In other words, one or more users or stakeholders may have tasks pending with them for the risk case number, implementation and review of controls, and so forth. For example, the task management module 165 can provide a pop up on user's computer to remind him of pending tasks at his end. It will be understood to a person ordinarily skilled in the art that several technologies can be used to flag pending tasks to a user and above examples are for the sake of clarity and do not intend to limit the scope of the disclosure.

In an embodiment of the present disclosure, the least one processor 110 also has a prediction module (not shown in FIG.). The prediction module computes strength of each of the predefined management competencies. As an example, since all root causes (say, related to “hard landing”) are linked to at least one management component of key word, (say “training & awareness”) then a repeated occurrence of a key word (in this example, it is “training and awareness”) would show that the Organization's training & awareness management system is weak & needs to be strengthened. Similarly, if a management keyword component “hazard identification” is linked to various root causes, it shows that employees/users in the organization are not educated to identify hazards in the organization. Therefore, by analyzing the key words data, the prediction module can predict the weak management components in an organization and recommend steps to be taken to strengthen these weak management components/systems in the Organization.

Moreover, the prediction module computes a probability of repeat of similar event. As an example, if a case of stray animal has been reported on the runway every three months (in the last two years), then taking into consideration the last such occurrence (say it happened around 60 days back), then the prediction module can warn the Organization that there is a very high probability of a stray animal entering the runway in the next 30 days. The Safety Officer can then analyze the previous cases for their root causes (say, the root cause in this case was fencing wire broken/wrongly placed) and undertake a review of entire fencing around the runway to prevent stray animal from entering the runway.

The prediction module also has suggestive capabilities such that it can suggest likely keywords from the plurality of predefined keywords words to be linked the one or more root causes and the one or more controls. As an example, if there is a breach of security at aerodrome, the analysis module will determine one or more root causes and controls which will be linked to aviation key words. During such a linking action once the user enters the word “Security”, the user will be prompted by all such predetermined aviation keywords like “Sabotage”, “Unlawful Entry”, “Aerodrome Security”, “Cargo Security”, “Security Generally” etc., from which the user can choose and link to the root causes and controls. Similarly the prediction module can suggest likely controls for the risk case number.

Finally, the risk management system 100 has an MIS module 170 that generates user-defined reports or pre-defined reports. The reports are based on at least one of a keyword, a classification and a source of inputs. As an example, an MIS report can be generated for cases reported as “Voluntary/Confidential/Anonymous Reports” (as ‘Source of Information’), which were classified (at ‘Level One’) as “Incident” related to sub-classification (at ‘Level two’) as “Ground Operations”, with further sub-sub-classification (at ‘Level three’) as “Runway Excursion—Animal”. This example will bring out all cases related to animal incursion which were classified as an “Incident”. However, if the User wants to find out all such cases of animal incursion which were classified as “Serious Incident”, then the ‘Level One’ classification will have to be appropriately changed to “Serious Incident”. In this way, the MIS module can generate user defined or pre-defined reports.

The present disclosure is significant technology enhancement over state of the art. The risk management system 100 provides predictive capabilities to avert potential risk. Further, the risk management system 100 allows periodic or non-periodic monitoring and review of root causes and associated controls. Moreover, the risk management system 100 undertakes proactive risk assessment for several situations such as for a new aviation operation. In addition, the risk management system 100 undertakes risk assessment along with appropriate controls to mitigate risks for new aviation operations. Moreover, the risk management system 100 undertakes risk assessment based in three or more parameters. Further, the risk management system 100 assesses strength or weakness of management components or departments.

The descriptions of embodiments of the present disclosure and accompanying examples are presented for purposes of the purpose of understanding and clarity. They are not intended to be exhaustive or to limit the scope of the present disclosure to the precise forms disclosed. It will be understood to a person ordinarily skilled in the art that many variations are possible in light of the above disclosure.

What is claimed is:

1. A risk management system 100 comprising:
at least one storage 105 configured to store a plurality of modules, wherein the plurality of modules is a collection of instructions of an application operable in the risk management system; and
at least one processor 110 configured to execute the plurality of modules, the plurality of modules comprising:
an input recorder module 115 configured to receive one or more input sets from one or more sources;
a case assignment module 120 configured to:
assign a risk case number to each of the one or more input sets, wherein the risk case number is unique, wherein the risk case number relates to an existing risk case or a new risk case;
assign each of the risk case number to a predefined safety officer; and
assign a predefined approving authority to each of the risk case number;
a level one review module 125 configured to perform exactly one action from a first plurality of actions for the risk case number, wherein the exactly one action is based on inputs of the predefined safety authority, wherein the first plurality of actions is initiate a risk computation, initiate a root cause analysis, and a closure, further wherein one or more predefined analysts and a predefined ultimate accountable department are defined when the first action is one of initiate a risk assessment and initiate a root cause analysis;
an analysis module 130 comprising:
a root cause analysis module 135 configured to identify one or more root causes by undertaking a root cause analysis for the risk case number when the level one review module initiates a root cause analysis, wherein the root cause analysis is performed independently by the one or more predefined analysts and the predefined ultimate accountable department, wherein the predefined ultimate accountable department recommends at least one of one or more new controls and one or more existing control for the risk case number;
a risk computation module 140 configured to compute a first risk by undertaking a risk assessment for the risk case number when the level one review module initiates a risk computation, wherein the risk computation is performed independently by the one or more predefined analysts and the predefined ultimate accountable department, wherein the one or more predefined analysts and the predefined ultimate accountable department recommend a first set of controls for the risk case number, wherein the first set of controls is at least one of one or more new controls and one or more existing control; and
an approval module 145 configured to finalize one or more of the risk computation, the root cause analysis and the first set of controls for the risk number, wherein finalization of one of the risk computation, the root cause analysis and the first set of controls is based on inputs of the predefined approving authority, wherein the predefined approving authority is capable of initiating one-on-one discussion with the ultimate accountable department in a discussion forum module before finalization of one of the risk computation, the root cause analysis and the first set of controls;
a root cause management module 150 configured to structure the root cause analysis in a first predefined structure, further wherein the root cause management module is configured to assign a root cause number to the root cause analysis, wherein the root cause number is one of a unique root cause number and an existing root cause number, wherein the root cause analysis is assigned the existing root cause number when the root cause analysis exactly matches an existing root cause analysis, wherein the root cause analysis is assigned the unique root cause number when the root cause analysis does not match an existing root cause analysis, further wherein the root cause management module is configured to assign one or more identified root causes of the root cause analysis for the risk case number to a first plurality of predefined keywords, wherein the first plurality of predefined keywords comprises predefined aviation terms and predefined management components, wherein the first plurality of predefined keywords includes at least one of the predefined management components, wherein the first plurality of predefined keywords are assigned based on inputs of the predefined safety officer; and
a control management module 155 configured to structure the first set of controls in a second predefined structure, further wherein the control management module assigns each control of the first set of controls to exactly one accountable department, further wherein the control management module assign a responsible user, one or more consulted users, and one or more informed users based on inputs of the accountable department and one or more advisors, wherein each control of the first set of controls has a unique control id, further wherein the control management module defines schedule for implementation and review of the first set of controls, further wherein the control management module submit the first set of controls to the predefined approving authority after discussion in the discussion forum module, wherein the first set of controls become active after approval for the approving authority;
a keywords module 160 configured to linking the first set of controls and the risk case number to a second plurality of predefined keywords, wherein the second plurality of predefined keywords comprises the predefined aviation terms and at least one predefined management components, wherein linking of the first set of controls and the risk case number to the second plurality of predefined keywords is based on inputs of the predefined safety officer;
a task management module 165 configured to flag pending tasks to one or more users of the risk management system; and
an MIS module 170 configured to generate one or more reports, wherein the one or more reports are at least one of user-defined report and a pre-defined report, wherein one or more reports is based on at least one of a keyword, a classification and a source of inputs.

2. The risk management system as recited in claim 1, wherein the least one processor further comprising a prediction module, wherein the prediction module:
computes a strength of each of the predefined management competencies;
computes a probability of repeat of similar event;
suggests likely keywords from the plurality of predefined keywords words to be linked the one or more root causes and the one or more controls; and
suggest likely controls for the risk case number.

3. The risk management system as recited in claim 1, wherein the one or more sources are selected from a group comprising safety reporting, questionnaires, surveys, flight data monitoring, safety and quality audit, operations, moderated sessions with internal experts, brainstorm sessions on new or known hazards, external sources and categories of safety reporting by International Civil Aviation Organization (ICAO).

4. The risk management system as recited in claim 1, wherein the level one review module assigns a predefined category to the risk case number, wherein the predefined category is one or more of ICAO classification and Country specific classification.

5. The risk management system as recited in claim 1, wherein the level one review module assigns a predefined category to the risk case number for the risk assessment analysis, wherein the risk computation module performs:
a three level classification when the predefined category is Air Operations as per ICAO; and
a two level classification when the predefined category is Hazard as per ICAO.

6. The risk management system as recited in claim 1, wherein the level one review module assigns a predefined category to the risk case number for the root cause analysis, wherein the root cause analysis module does a three level classification when the predefined category is one of a country specific incident and an incident as per ICAO.

7. The risk management system as recited in claim 1, wherein the risk computation module performs:
listing the existing controls for the risk case number;
computing the first risk based on existing controls on exactly two predefined parameters, wherein the first risk is computed based on a predefined likelihood and a predefined severity associated with the risk case number, wherein the predefined likelihood and the predefined severity is based on ICAO;
recommending action as per a risk acceptability matrix based on ICAO or user defined; and
if the predefined risk is not less than a predefined risk limit, recommending one or more additional controls such that the predefined risk is less than the predefined risk limit.

8. The risk management system as recited in claim 1, wherein the risk computation module performs:
computing the first risk based on three or more parameters; and
if the first risk is not less than a predefined risk limit, recommending one or more additional controls such that the predefined risk is less than the predefined risk limit.

9. The risk management system as recited in claim 1, wherein the predefined aviation terms comprises the predefined aviation terms are as per ICAO, ECCAIRA 1.3.0.12.

10. The risk management system as recited in claim 1, wherein the predefined management competencies comprises policy and objectives, safety risk management, safety assurance, and safety promotion.

11. A risk management system comprising:
at least one storage configured to store a plurality of modules, wherein the plurality of modules is a collection of instructions of an application operable in the risk management system:
at least one processor configured to execute the plurality of modules, the plurality of modules comprising:
an input recorder module configured to receive one or more input sets from one or more sources, wherein the one or more sources are selected from a group comprising safety reporting, questionnaires, surveys, flight data monitoring, safety and quality audit, operations, moderated sessions with internal experts, brainstorm sessions on new or known hazards, external sources and categories of safety reporting by International Civil Aviation Organization (ICAO);
a case assignment module configured to:
assign a risk case number to each of the one or more input sets, wherein the risk case number is unique, wherein the risk case number relates to an existing risk case or a new risk case;
assign each of the risk case number to a predefined safety officer; and
assign a predefined approving authority to each of the risk case number;
a level one review module configured to perform exactly one action from a first plurality of actions for the risk case number, wherein the exactly one action is based on inputs of the predefined safety authority, wherein the first plurality of actions is initiate a risk computation, initiate a root cause analysis, and a closure, further wherein one or more predefined analysts and a predefined ultimate accountable department are defined when the first action is one of initiate a risk assessment and initiate a root cause analysis, wherein the level one review module further assigns a predefined category to the risk case number for the risk assessment analysis, further wherein the risk computation module does a three level classification when the predefined category is Air Operations as per ICAO and a two level classification when the predefined category is Hazard as per ICAO;
an analysis module comprising:
a root cause analysis module 135 configured to identify one or more root causes by undertaking a root cause analysis for the risk case number when the level one review module initiates a root cause analysis, wherein the root cause analysis is performed independently by the one or more predefined analysts and the predefined ultimate accountable department, wherein the predefined ultimate accountable department recommends at least one of one or more new controls and one or more existing control for the risk case number;
a risk computation module 140 configured to compute a first risk by undertaking a risk assessment for the risk case number when the level one review module initiates a risk computation, wherein the risk computation is performed independently by the one or more predefined analysts and the predefined ultimate accountable department, wherein the one or more predefined analysts and the predefined ultimate accountable department recommend a first set of controls for the risk case number, wherein the first set of controls is at least one of one or more new controls and one or more existing control; and an approval module 145 configured to finalize one or more of the risk computation, the root cause analysis and the first set of controls for the risk number, wherein finalization of one of the risk computation, the root cause analysis and the first set of controls is based on inputs of the predefined approving authority, wherein the predefined approving authority is capable of initiating one-on-one discussion with the ultimate accountable department in a discussion forum module before finalization of one of the risk computation, the root cause analysis and the first set of controls;
a root cause management module 150 configured to structure the root cause analysis in a first predefined structure, further wherein the root cause management module is configured to assign a root cause number to the root cause analysis, wherein the root cause number is one of a unique root cause number and an existing root cause number, wherein the root cause analysis is assigned the existing root cause number when the root cause analysis substantially matches an existing root cause analysis, wherein the root cause analysis is assigned the unique root cause number when the root cause analysis does not match an existing root cause analysis, further wherein the root cause management module is configured to assign one or more identified root causes of the root cause analysis for the risk case number to a first plurality of predefined keywords, wherein the first plurality of predefined keywords comprises predefined aviation terms and predefined management components, wherein the first plurality of predefined keywords includes at least one of the predefined management components, the predefined management components comprises policy and objectives, safety risk management, safety assurance, and safety promotion, wherein the first plurality of predefined keywords are assigned based on inputs of the predefined safety officer;
a control management module configured to structure the first set of controls in a second predefined structure, further wherein the control management module assigns each control of the first set of controls to exactly one accountable department, further wherein the control management module assign a responsible user, one or more consulted users, and one or more informed users based on inputs of the accountable department and one or more advisors, wherein each control of the first set of controls has a unique control id, further wherein the control management module defines schedule for implementation and review of the first set of controls, further wherein the control management module submit the first set of controls to the predefined approving authority after discussion in the discussion forum module, wherein the first set of controls become active after approval for the approving authority;
a keywords module configured to linking the first set of controls and the risk case number to a second plurality of predefined keywords, wherein the second plurality of predefined keywords comprises the predefined aviation terms and at least one predefined management components, wherein linking of the first set of controls and the risk case number to the second plurality of predefined keywords is based on inputs of the predefined safety officer;
a task management module configured to flag pending tasks to one or more users of the risk management system; and
an MIS module configured to generate one or more reports, wherein the one or more reports are at least one of user-defined report and a pre-defined report, wherein one or more reports is based on at least one of a keyword, a classification and a source of inputs.

12. The risk management system as recited in claim 11, wherein the least one processor further comprising a prediction module, wherein the prediction module:
computes a strength of each of the predefined management competencies;
computes a probability of repeat of similar event;
suggests likely keywords from the plurality of predefined keywords words to be linked the one or more root causes and the one or more controls; and
suggests likely controls for the risk case number.

13. The risk management system as recited in claim 11, wherein the level one review module assigns a predefined category to the risk case number, wherein the predefined category is one or more of ICAO classification and Country specific classification.

14. The risk management system as recited in claim 11, wherein the level one review module assigns a predefined category to the risk case number for the root cause analysis, wherein the root cause analysis module does a three level classification when the predefined category is one of a country specific incident and an incident as per ICAO.

15. The risk management system as recited in claim 11, wherein the risk computation module performs:
listing the existing controls for the risk case number;
computing the first risk based on existing controls on exactly two predefined parameters, wherein the first risk is computed based on a predefined likelihood and a predefined severity associated with the risk case number, wherein the predefined likelihood and the predefined severity is based on ICAO;
recommending action as per a risk acceptability matrix based on ICAO or user defined; and
if the predefined risk is not less than a predefined risk limit, recommending one or more additional controls such that the predefined risk is less than the predefined risk limit.

16. The risk management system as recited in claim 11, wherein the risk computation module performs:
computing the first risk based on three or more parameters; and
if the first risk is not less than a predefined risk limit, recommending one or more additional controls such that the predefined risk is less than the predefined risk limit.

17. The risk management system as recited in claim 11, wherein the predefined aviation terms comprises the predefined aviation terms are as per ICAO, ECCAIRA 1.3.0.12.
